(19) United States
(12) Patent Application Publication
(10) Pub. No.: US 2022/0118591 A1
(43) Pub. Date: Apr. 21, 2022

(54) PORTABLE TOOL FOR A HOLLOW WALL ANCHOR

(71) Applicant: SCELL-IT, Lesquin (FR)

(72) Inventors: Franck DEBRUYNE, LESQUIN (FR); Jérémy FOULON, LESQUIN (FR)

(21) Appl. No.: 17/503,485

(22) Filed: Oct. 18, 2021

(30) Foreign Application Priority Data
Oct. 19, 2020 (FR) 20 10727

(51) Int. Cl. B25B 27/00; B25F 5/00; B25B 21/00

(52) U.S. Cl. CPC B25B 27/0014; B25F 5/02; B25B 21/007; B25F 5/001

(57) ABSTRACT

Motor-driven portable tool configured so as to ensure the expansion of a wall anchor (Ch) of a screw (Vs) and wall anchor (Ch) set, with fine setting of the determined stroke of the effector.

### CROSS-REFERENCE TO RELATED APPLICATIONS

This application claims priority from French Patent Application No. 2010727 filed on Oct. 19, 2020. The French Patent Application is hereby expressly incorporated by reference herein in its entirety.

The present disclosure relates to a portable tool configured to ensure the expansion of a wall anchor (or a screw and wall anchor set).

### FIELD OF THE INVENTION

The field of the present invention relates to that of setting of so-called HWA (“Hollow Wall Anchor”) wall anchors, typically metallic, and better known as Molly wall anchors.

For such a wall anchor, the expansion of the wall anchor cannot be achieved by screwing of the screw, but requires a specific tool, namely an expansion-controlled clamp well known in the state of the art.

Thus, the mechanism of the clamp has two portions, movable relative to one another, namely a fixed portion and a slider bearing respectively against a shoulder of the wall anchor and the head of the screw, and enabling the separation of the screw head with respect to the shoulder of the wall anchor upon a movement of the slider, to cause the expansion of the wall anchor.

Conventionally, the clamp comprises a grip, with a fixed branch and a movable branch, which, when driven towards the fixed branch, allows causing the movement of the slider by a given step, and thus separate the head of the screw from the shoulder of the wall anchor.

The stroke necessary for the expansion of the wall anchor is not a fixed value and depends on the model of the wall anchor: with such a clamp, the optimum expansion of the wall anchor could require several presses on the grip to cause several consecutive movements of the slider (by the given step) up to the desired stroke.

### BACKGROUND

Some expansion-controlled clamps comprise a setting system which allows monitoring the stroke, by monitoring the number of presses on the grip and therefore the number of steps.

Nonetheless, according to the observations of the Applicant, this type of clamps has the drawback of requiring a large number of presses on the grip for the set-up of wall anchors, which could lead to musculoskeletal troubles for the operators.

Another drawback of expansion-controlled clamps, even those fitted with the aforementioned setting system, is that it is just a discontinuous setting, corresponding to the step of movement of the slider of the grip upon a press on the grip, which could turn out to be a coarse, merely accurate setting.

According to the observations of the inventors, and in particular for very long wall anchors, the expansion-controlled clamps available on the market have a stroke of the slider that is insufficient to ensure the optimum expansion of the wall anchor, even with several successive presses on the grip.

With such clamps, the expansion of the wall anchor may require a set-up procedure in two steps, namely, a first use of the clamp to separate the head of the screw from the shoulder of the wall anchor thereby proceeding with a first expansion, only partial, of the wall anchor.

The operator disengages the clamp from the wall anchor, to proceed with screwing of the screw, and thus with the approach of the head of the screw to the shoulder of the wall anchor, before engaging the expansion-controlled clamp again to ensure the desired expansion during a second use of the clamp.

Such a procedure, which comprises a screwing with a non-controlled stroke between two uses of the clamp, is not satisfactory, and does not allow guaranteeing the repeatability of the operations.

### SUMMARY OF THE INVENTION

The present disclosure improves the situation.

A portable tool is provided, configured to ensure the expansion of a wall anchor of a screw and wall anchor set wherein:
the screw has a screw head, with a diameter larger than a threaded portion of the screw,
the wall anchor, having a nut at a distal end inside which the screw is screwed, and a shoulder at a proximal end, intended to bear on a first face of a wall inside which the wall anchor is inserted, as well as a plurality of branches each connecting the nut to the shoulder, and wherein the tool comprises an effector comprising:
a bit having at its distal end a first bearing surface provided with a first indentation, having a face intended to come into contact with the shoulder of the wall anchor, as well as a slide extending from the opposite side to said face,
a slider, mounted movable in translation along the slide, carrying a second bearing surface provided with a second indentation configured to bear against the screw head,
a drive mechanism configured to move the slider from an initial first position, for which the second bearing surface is juxtaposed to the first bearing surface enabling the insertion of the screw throughout the indentations consisting of the first indentation and the second indentation with the contact of the first bearing surface against the shoulder of the hollow wall anchor inside which the screw is screwed and whose threaded portion crosses the first indentation and the juxtaposed second indentation, the screw head then being positioned opposite the second bearing surface and up to a second position for which the second bearing surface then in contact against the screw head is separated from the first bearing surface in contact with the shoulder by sliding of the slider along the slide causing the separation of the screw head with respect to the shoulder of the wall anchor, and thus the expansion of the wall anchor by deformation of the branches by the approach of the nut and the shoulder.

According to the present disclosure, the drive mechanism comprises an electric motor comprising a rotor and a stator, as well as a transmission ensuring the movement of the slider along the slide during the rotation of the rotor, as well as a monitoring module comprising a control member, said monitoring module being configured, when the operator presses on said control member, to actuate the motor in order to drive the slider from the first position towards the second position.

The features disclosed in the following paragraphs may, optionally, be implemented. They may be implemented independently of each other or in combination with each other.

According to one embodiment, the control member is an electric button preferably with a normally-open switch, pressing on said control member ensuring the actuation of the electric motor, and the release of the control member the stoppage of the motor.

According to one embodiment, the monitoring member comprises a motor board ensuring the automatic stoppage of the slider in the second position when the slider reaches a determined stroke between said first position and said second position of the slider.

According to one embodiment, the monitoring member comprises a user interface configured to ensure the setting of the value of the determined stroke.

According to one embodiment, the user interface is a rotary setting knob. The setting knob may be secured to the rotary axis of a potentiometer, the monitoring module comprising the motor board connected to the terminals of the potentiometer and associating different values of the determined stroke to different values of the variable resistance at the terminals of the potentiometers.

According to one embodiment, the value of the stroke can be set over a range that extends up to at least 44 mm for the value of the determined stroke.

According to one embodiment, said user interface ensures the setting of the value of the determined stroke according to a setting increment smaller than or equal to 3 mm, preferably smaller than or equal to 2 mm, or smaller than or equal to 1 mm.

According to one embodiment, the transmission between the rotor of the electric motor comprises a screw/nut system, configured to transform the rotational movement of the rotor of the motor into a translational movement of the slider.

According to one embodiment, the bit comprises a barrel terminating at its distal end in the first bearing surface, and connected at its proximal end to a body of the tool embedding the motor, and possibly a reducer as well as the monitoring module, and wherein the tubular barrel comprises a housing forming a slide for the slider, with blockage of the rotation of the slider relative to the barrel about a longitudinal axis of the barrel.

According to one embodiment, the screw of the screw-nut system extends inside the barrel, guided in rotation by a bearing such as a rolling bearing connecting the screw and the inner wall of the barrel, and said nut is mounted movable in translation inside the housing, without any possibility of rotation of the nut relative to the barrel around a longitudinal axis of the barrel.

According to one embodiment, the bit and the body of the tool comprise removable fastening means between the proximal end of the barrel and the body of the tool, comprising for example a retaining ring and wherein the end of the screw at the proximal end of the barrel, on the one hand, and the output of the reducer of the body of the tool, on the other hand, comprise removable complementary portions for coupling by nesting, ensuring a torque transmission.

According to one embodiment, the user interface is located on the rear portion of the body of the tool, diametrically opposite with respect to the bit connected to the front portion of the body of the tool.

According to one embodiment, the tool comprises a grip, and wherein said control member is a trigger configured to be pressed by a finger such as the forefinger of the hand grasping the grip.

According to one embodiment, the energy source of the motor and of the monitoring module is a battery, possibly provided removable with respect to the body of the tool.

According to one embodiment, the monitoring module comprises a selector of the rotation direction of the motor, configured to take on two states, including:
a first state in which a press on the control member causes the rotation of the motor in the direction allowing the advance of the slider from the first position towards the second position,
a second state in which a press on the control member causes the rotation of the motor in the direction allowing the return of the slider from the second position towards the initial first position.

### BRIEF DESCRIPTION OF THE DRAWINGS

Other features, details and advantages will appear upon reading the detailed description hereinafter, and upon analysing the appended drawings, wherein:

FIG. 1 shows a hollow wall anchor and its screw, including a threaded portion and a screw head.

FIG. 2 shows, to the left, a side view of a tool in accordance with an embodiment, illustrating in transparency the rotor of the electric motor, as well as the bit of the effector, in the first position of the slider for which the second bearing surface is juxtaposed to the first bearing surface, before pressing by the operator on the control member, and to the right, the rotary knob of the user interface set on a determined stroke of the slider of x mm.

FIG. 3 is an exploded partial perspective view of the tool according to FIG. 2.

FIG. 4 is a sectional view of the tool according to FIG. 3, passing through a plane of symmetry of the tool.

FIG. 5 is a view of the distal end of the bit, including the first bearing surface and the second bearing surface of the slider, one behind another in the first position of the slider.

FIG. 6 is a schematic view of a wall anchor in a hole of a wall board, illustrating a movement of the slider when the first bearing surface of the bit is in contact against the shoulder of the wall anchor, the second bearing surface of the slider cooperating with the head of the screw to ensure the separation of the screw head with respect to the shoulder of the wall anchor while causing the expansion of the wall anchor, by folding of the branches of the wall anchor.

FIG. 7a to the left, is a view of the tool, after pressing on the trigger of the control member, the selector in the first state, until the monitoring module ensures the stoppage of the slider for a determined strike with a value set at x mm, and to the right, the knob directed so as to ensure the determined stroke of x mm.

FIG. 7b is a view of the tool of FIG. 7a, after pressing on the trigger of the control member, the selector in the first state, until the monitoring module ensures the stoppage of the slider for a determined stroke with a value set at y mm (with y>x), and to the right, the knob directed so as to ensure the determined stroke of y mm.

FIG. 8 is a sectional view of the barrel of the bit, illustrating the section of the slider and the inner section of the housing of the barrel forming a slide, configured to cooperate, within the sliding clearance margin, the substantially non-circular sections, within the rectangular space.

FIG. 9 is a sectional view of the barrel, according to a plane perpendicular to the axis of the screw, the nut of the screw/nut system provided with a pad, secured to the nut, with a rectangular section, configured to cooperate, within the sliding clearance margin, with the section of the housing of the barrel.

FIG. 10 is a diagram of the monitoring member, schematically illustrating the electric motor, the selector of the rotation direction of the motor, the motor board, the control member, and the potentiometer of the interface enabling the setting of the value of the determined stroke.

### DETAILED DESCRIPTION

The drawings and the description hereinafter essentially contain elements that are definitely certain. Hence, they could not only serve to better understand the present disclosure, but also contribute to the definition thereof, where appropriate.

The present disclosure relates to a portable tool 1 configured to ensure the expansion of a hollow wall anchor Ch of a screw Vs and wall anchor Ch set, such as a Molly wall anchor.

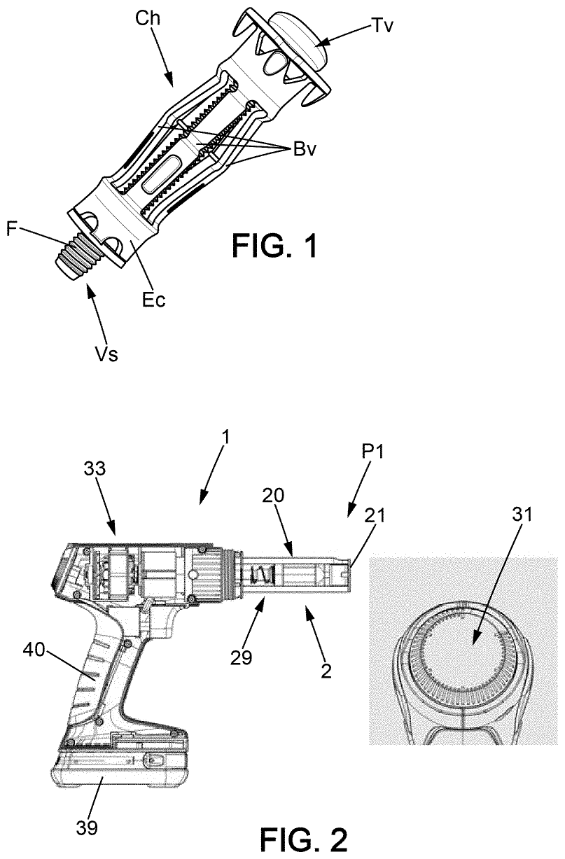

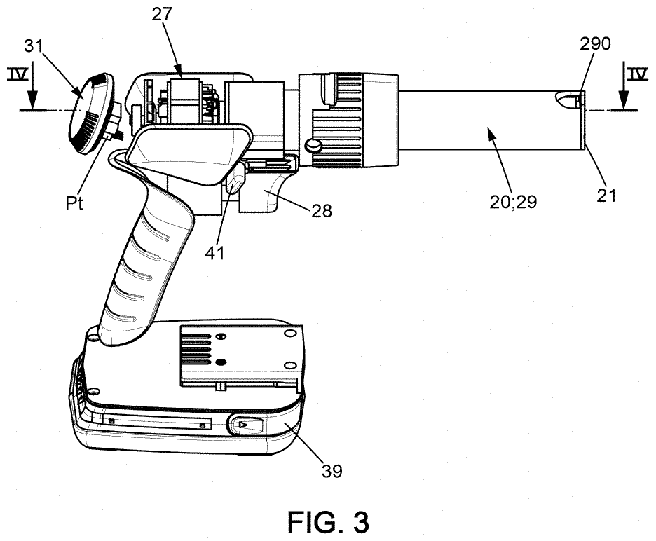

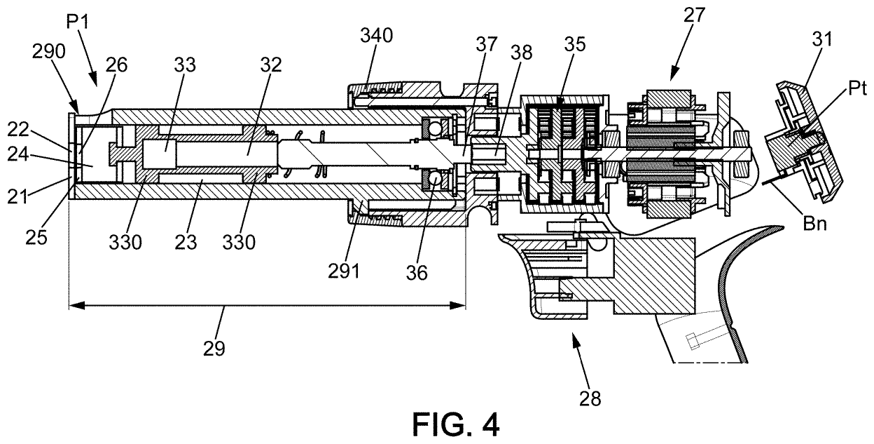

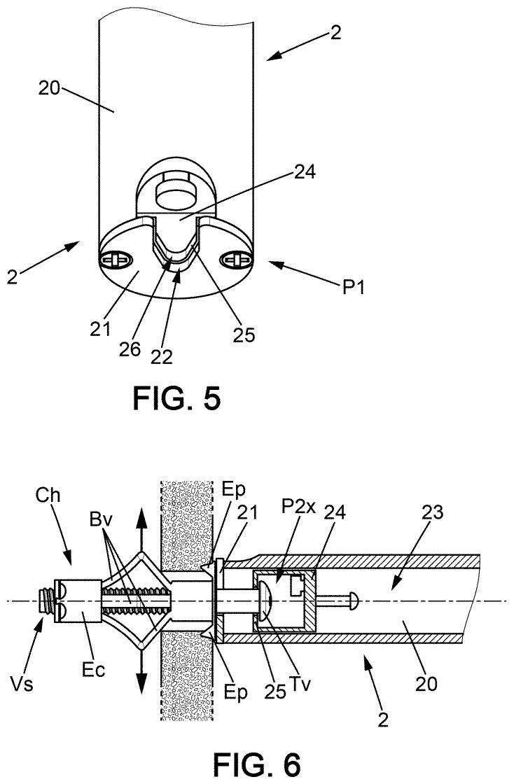

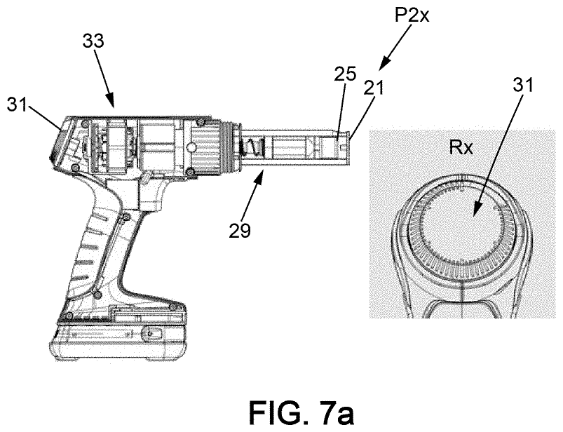

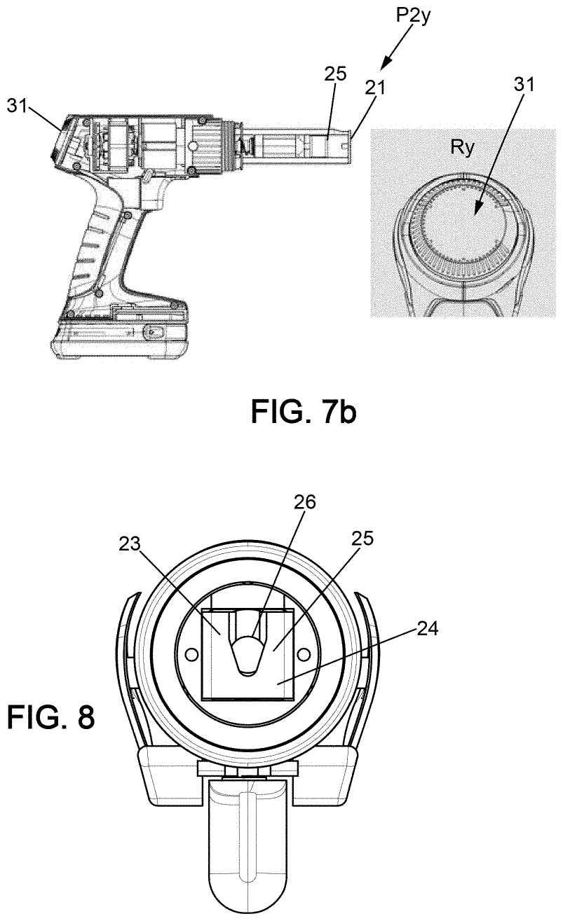

Such a set is illustrated in FIG. 1 and comprises:
the screw Vs having a screw head Tv, with a diameter larger than a threaded portion F of the screw,
the wall anchor Ch, having at a distal end a nut Ec into which the screw Vs is screwed, and at a proximal end, a shoulder Ep.

This shoulder Ep is intended to bear on a first face of a wall throughout which the wall anchor is inserted and as illustrated in FIG. 6. Claws may be provided on the shoulder to encroach the wall.

The wall anchor also comprises a plurality of branches Br each connecting the nut Ec to the shoulder Ep. The wall anchor expansion is obtained by deformation of the branches, in particular by folding of the branches, while ensuring the approach of the shoulder Ep with the nut Ec which, in turn, is obtained by separating the screw head Tv from the shoulder Ep, and as illustrated as example in FIG. 6.

To this end, the tool 1 has an effector 2 comprising:
a bit 20 having at its distal end a first bearing surface 21 provided with a first indentation 22, having a face intended to come into contact with the shoulder Ep of the wall anchor, as well as a slide 23 extending from the opposite side to said face,
a slider 24, mounted movable in translation along the slide 23, carrying a second bearing surface 25 provided with a second indentation 26 configured to bear against the screw head Tv.

The tool also comprises a drive mechanism configured to move the slider 24 from an initial first position P1, for which the second bearing surface 25 is juxtaposed to the first bearing surface 21. This initial first position enables the insertion of the screw throughout the first and second indentations 22, 26 then opposite one another and juxtaposed, with contact of the first bearing surface 21 against the shoulder Ep of the hollow wall anchor Ch into which the screw Vs is screwed. The threaded portion of the screw then crosses the juxtaposed first indentation 22 and second indentation 26. The screw head Tv, with a dimension larger than the second indentation 26, is then positioned opposite the second bearing surface 25, and prone to be pulled by the second bearing surface 25 when the slider 24 separates the second bearing surface 25 from the first bearing surface 21. In this position, the second bearing surface 25 is positioned intermediate between the first bearing surface 21 and the screw head Tv.

The drive mechanism is configured to move the slider 24 from said first position P1 up to a second position P2x; P2y for which the second bearing surface 25 then in contact against the screw head is separated from the first bearing surface 21 in contact with the shoulder Ep of the wall anchor, by sliding of the slider 24 along the slide 23. This movement causes the separation of the screw head Tv from the shoulder Ep of the wall anchor, and thus the expansion of the wall anchor Ch by deformation of the branches Br by the approach of the nut Ec and the shoulder Ep.

In FIG. 6, and in general, it is noticed that the movement of the slider up to the second position P2x allows approaching the shoulder Ep and the nut Ec, with deformation of the branches outwardly, and in particular folding thereof at the middle folding area of the branch Br and until obtaining holding of the wall anchor through a hole in a surface (in particular a wall), bearing, on the one hand, on the first face of the wall by the shoulder Ep of the wall anchor, and on the other hand, on the second face of the wall surface by bearing of the deformed, in particular folded, branches Br.

Advantageously, according to the present disclosure, the drive mechanism comprises an electric motor M comprising a rotor 27 and a stator, as well as a transmission ensuring the movement of the slider 24 along the slide 23 during the rotation of the rotor, as well as a monitoring module 30 comprising a control member 28. This monitoring module is configured, when the operator presses on said control member 28, to actuate the motor in order to drive the slider 24 from the first position P1 towards the second position P2x, P2y.

Such a tool ensures the wall anchor expansion in a motor-driven manner, advantageously while reducing the efforts for the user in comparison with a toll with a (manual) clamp mechanism.

According to one embodiment, the control member 28 is an electric button with a normally-open switch, pressing on said control member 28 ensuring the actuation of the electric motor M, and the release of the control member 28 the stoppage of the motor. The control member 28 and the switch may feature an all-or-nothing operation, or alternatively advantageously a progressive operation, with monitoring of the variation of the rotational speed of the motor, in particular according to the stroke of the press on the control member 28.

In general, the tool may comprise a grip 40: said control member 28 may be a trigger configured to be pressed by a finger such as the forefinger of the hand grasping the grip 40.

According to one embodiment, the monitoring module 30 comprises a selector 41 of the rotation direction of the electric motor M, configured to take on at least two states, including:
a first state in which a press on the control member 28 causes the rotation of the motor in the direction allowing the advance of the slider 24 from the first position P1 towards the second position P2x, P2y,
a second state in which a press on the control member 28 causes the rotation of the motor in the direction allowing the return of the slider from the second position P2x, P2y towards the initial first position P1.

According to an advantageous embodiment, the monitoring module 30 comprises a motor board CM ensuring the automatic stoppage of the slider 24 in the second position P2x, P2y when the slider reaches a determined stroke between said first position P1 and said second position P2x, P2y of the slider 24, memorised in the memory card.

To this end, the motor board CM may consist of a board with monitoring of the position of the motor, the board ensuring the automatic stoppage of the motor when the slider reaches the second position P2x, P2y and in particular when the operator keeps pressing on the control member 28.

Advantageously, the determined stroke is herein selected according to the characteristics of the hollow wall anchor Ch, and possibly of the support on which the wall anchor is set, in particular the thickness of the wall surface into which the wall anchor is inserted. The determined stroke is determined in order to obtain the deformation of the branches ensuring the optimum holding of the wall anchor.

The determined stroke is selected with a sufficient value to cause the deformation of the branches in order to obtain the suppression of the mounting backlash in the wall surface between the shoulder and the deformed branches, but with no excess otherwise the support will be marked, for example the plasterboard when the determined stroke is exceeded.

According to an advantageous embodiment, the monitoring module 30 comprises a user interface 31 configured to ensure the setting of the value x, y of the determined stroke.

The user interface 31 may consist of a rotary setting knob. This setting knob 31 may be secured to the rotary axis of a potentiometer Pt.

The monitoring module 30 then comprises the motor board CM connected to the terminals of the potentiometer and associating different values x, y of the determined stroke to different values of the variable resistance at the terminals Bn of the potentiometer Pt.

The user interface 31 may be in other forms such as a digital display with one or several button(s) allowing setting of the determined stroke. Such an interface allows setting the value of the determined stroke according to the characteristics of the wall anchor and of the support, and according to different wall anchor dimensions. It becomes possible to ensure an optimum deformation of the branches during the expansion of the wall anchor, in a repeatable and reliable manner, and advantageously irrespective of the wall anchor model.

Advantageously, the setting of the determined stroke is preferably a fine setting: said user interface 31 ensures a setting of the value of the stroke preferably determined according to a setting increment smaller than or equal to 3 mm, preferably smaller than or equal to 2 mm, and possibly smaller than or equal to 1 mm, and even a continuous setting of the value of the determined stroke.

According to one embodiment, the stroke of the slider may be at least equal to 44 mm. According to the observations of the inventors, such a stroke of the slider, from the first position P1 up to the second position P2x, P2y enables setting and expansion of the wall anchors available on the market, even the longest ones. Preferably, said user interface ensures a setting of the value of the determined stroke over a range that extends up to at least 44 mm for the determined stroke of the slider.

According to one embodiment, the transmission between the rotor 27 of the electric motor M comprises a screw 32/nut 33 system, configured to transform the rotational movement of the rotor 27 of the motor M into a translational movement of the slider 24.

According to an embodiment illustrated in the figures, the rotor 27 of the motor M drives the rotation of the screw 32 on itself preferably through a reducer 35, while the nut 33 in cooperation with the screw is movable in translation along the direction of the slide 23. The reducer 35 may consist of an epicyclic gear train, for example a multi-stage one.

Thus, the bit 20 may comprise a barrel 29 terminating at its distal end in the first bearing surface 21, and connected at its proximal end to a body 34 of the tool. The body 34 of the tool embeds the motor M, and possibly said reducer 35 as well as the monitoring module 30. The barrel may have a cylindrical external shape, the first bearing surface 21 forming the base at the distal end of the barrel.

The barrel 29 is tubular with a housing forming a slide 23 for the slider. The tubular housing of the barrel has a non-circular section, for example a rectangular or square section. The section of the slider is complementary with the sliding clearance, ensuring the guidance of the slider in the housing forming a slide, with a blockage of the rotation of the slider 24 relative to the barrel about the longitudinal axis of the barrel.

Notice that the external wall of the barrel 29, cylindrical in particular, has a notch 290, with a dimension larger than the screw head Tv, opening facing the first bearing surface 21, opposite the first indentation 22. When the slider is in the first position P1 for which the second bearing surface 25 and the first bearing surface 21 are juxtaposed, this notch 290 enables the insertion of the screw head within the barrel, until positioning the threaded portion of the screw throughout the first and second indentations 22, 26 of the first and second bearing surfaces 21, 25 then juxtaposed. Once the screw head is inserted into the barrel, the second bearing surface 25 is then positioned intermediate between the first bearing surface 21 and the screw head Tv, along the direction of the barrel.

Notice that the screw 32 of the screw-nut system could extend inside the barrel, guided in rotation relative to the barrel by a bearing such as a rolling bearing 36 connecting the screw 32 and the inner wall of the barrel 29. The nut 33 is mounted movable in translation inside the housing, without any possibility of rotation of the nut relative to the barrel about a longitudinal axis of the barrel. The nut 33 may have one or several pad(s) 330, ensuring a guidance of the nut.

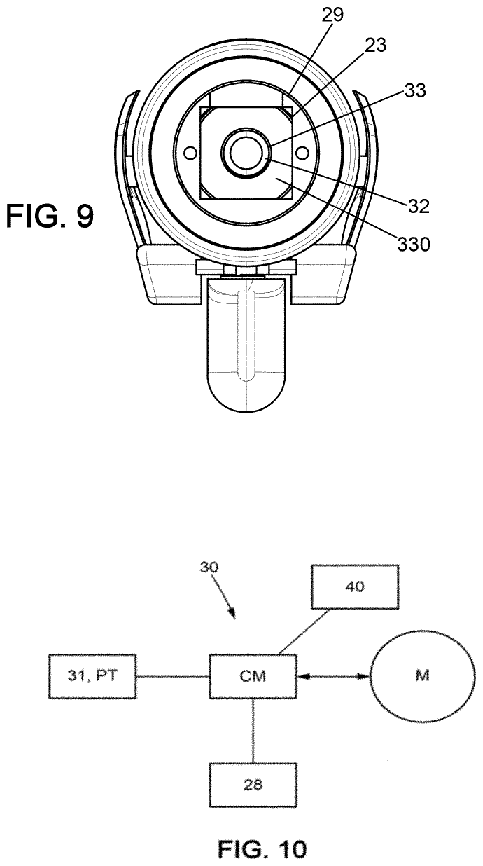

For example, the nut 33 has two pads 330 whose positions are offset along the axis of the barrel. As illustrated according to the sectional view of FIG. 9, the section of the or each pad 330 may be complementary with the non-circular section of the housing, and in order to block the rotation of the nut 33 about its axis. For example, the (or each) pad 330 has a rectangular (or square) section complementary, within the sliding clearance margin, with the section of the housing.

According to one embodiment, the bit 20 and the body 34 of the tool comprise removable fastening means between the proximal end of the barrel 29 and the body 34 of the tool.

Moreover, the end of the screw 32 at the proximal end of the barrel, on the one hand, and the output of the reducer 35 of the body of the tool, on the other hand, may respectively comprise complementary portions 37, 38 for coupling by nesting, ensuring a torque transmission. These complementary portions ensure a quick coupling between the output of the reducer 35 and the screw 32 when the proximal end of the barrel is nested into the body of the tool.

The removable fastening means may comprise a retaining ring 340 ensuring the blockage of the barrel 29, nested by its proximal end into the body 34, by bearing of the retaining ring 340 against a portion 291 at the proximal end of the barrel. This ring 340 extends around the barrel and has an inner thread screwed onto the body 34 of the tool, while ensuring the removable coupling of the complementary portions 37 and 38. The removal of the barrel 29 requires the prior removal of the retaining ring 340 by unscrewing, and before enabling the extraction of the barrel 29.

Preferably, the tool 1 is powered by a standalone electrical energy source such as a battery. This energy source powers the motor M and the monitoring module 30. This battery 39 is possibly provided removable with respect to the body 34 of the tool.

### INDUSTRIAL APPLICATION

The tool will find a particular application in setting of a hollow wall anchor, for example a Molly wall anchor.

The tool has as advantage a reduction of the risk of musculoskeletal troubles for the operators, and allows, at least according to one embodiment:
an optimum set-up of the wall anchor, with the suppression of the mounting backlash, and without any risk of marking the support, with a great repeatability of the operations
a compatibility with the wall anchors available on the market, including the longest ones which could be set seamlessly.

### LIST OF THE REFERENCE SIGNS

1: Portable tool,
2. Effector,
20. Bit,
21. First bearing,
22. First indentation,
23. Slide,
24. Slider,
25. Second bearing,
26. Second indentation,
27. Rotor,
28. Control member,
29. Barrel,
291 Portion of the barrel (stopped by the retaining ring 340),
30. Monitoring module,
31. User interface (setting of the determined stroke, in particular setting knob),
32, 33. Respectively screw and nut of the screw-nut system,
34. Body of the tool,
340. Retaining ring,
35. Reducer,
36. Rolling bearing,
37,38. Complementary coupling portions fitting y nesting,
39. Battery,
40. Grip,
41. Selector of the rotation direction,
Br. Branches,
Ch. Wall anchor,
Ec. Nut,
Ep. Shoulder,
F. Threaded portion,
M. Electric motor,
Tv. Screw head,
Vs. Screw,
P1. (initial) First position,
P2x, P2y. Second position,
Pt. Potentiometer,
Bn. Potentiometer terminal,
Rx, Ry. Knob settings at x and y mm, respectively,
290. Notch,
330. Pads,
CM. Motor board.

1. A portable tool (1) configured to ensure the expansion of a wall anchor (Ch) of a screw (Vs) and wall anchor set wherein:
the screw (Vs) has a screw head (Tv), with a diameter larger than a threaded portion (F) of the screw,
the wall anchor (Ch), having a nut (Ec) at a distal end inside which the screw is screwed, and a shoulder (Ep) at a proximal end, intended to bear on a first face of a wall inside which the wall anchor is inserted, as well as a plurality of branches (Br) each connecting the nut (Ec) to the shoulder (Ep), and wherein the tool comprises an effector (2) comprising:
a bit (20) having at its distal end a first bearing surface (21) provided with a first indentation (22), having a face intended to come into contact with the shoulder (Ep) of the wall anchor, as well as a slide (23) extending from the opposite side to said face,
a slider (24), mounted movable in translation along the slide (23), carrying a second bearing surface (25) provided with a second indentation (26) configured to bear against the screw head (Tv),
a drive mechanism configured to move the slider (24) from an initial first position (P1), for which the second bearing surface (25) is juxtaposed to the first bearing surface (21) enabling the insertion of the screw (Vs) throughout the indentations consisting of the first indentation (22) and the second indentation (26) with the contact of the first bearing surface (21) against the shoulder (Ep) of the hollow wall anchor (Ch) inside which the screw (Vs) is screwed and whose threaded portion crosses the first indentation (22) and the juxtaposed second indentation (26), the screw head (Tv) then being positioned opposite the second bearing surface (25) and up to a second position (P2x; P2y) for which the second bearing surface (25) then in contact against the screw head is separated from the first bearing surface (21) in contact with the shoulder (Ep) by sliding of the slider (24) along the slide (23) causing the separation of the screw head (Tv) with respect to the shoulder (Ep) of the wall anchor, and thus the expansion of the wall anchor (Ch) by deformation of the branches (Br) by the approach of the nut (Ec) and the shoulder (Ep) characterised in that the drive mechanism comprises an electric motor (M) comprising a rotor (27) and a stator, as well as a transmission ensuring the movement of the slider (24) along the slide (23) during the rotation of the rotor, as well as a monitoring module (30) comprising a control member (28), said monitoring module being configured, when the operator presses on said control member (28), to actuate the motor in order to drive the slider (24) from the first position (P1) towards the second position (P2x, P2y).

2. The portable tool according to claim 1, wherein the control member (28) is an electric button preferably with a normally-open switch, pressing on said control member (28) ensuring the actuation of the electric motor (M), and the release of the control member (28) the stoppage of the motor.

3. The portable tool according to claim 2, wherein the monitoring member (30) comprises a motor board (CM) ensuring the automatic stoppage of the slider (24) in the second position (P2x, P2y) when the slider reaches a determined stroke between said first position (P1) and said second position (P2x, P2y) of the slider (24).

4. The portable tool according to claim 3, wherein the monitoring member (30) comprises a user interface (31) configured to ensure the setting of the value (x, y) of the determined stroke.

5. The portable tool according to claim 4, wherein the user interface (31) is a rotary setting knob.

6. The portable tool according to claim 5, wherein the setting knob (31) is secured to the rotary axis of a potentiometer (Pt), the monitoring module (30) comprising the motor board (CM) connected to the terminals of the potentiometer and associating different values (x, y) of the determined stroke to different values of the variable resistance at the terminals (Bn) of the potentiometers (Pt).

7. The portable tool according to claim 4, wherein the value of the stroke can be set over a range that extends up to at least 44 mm for the value of the determined stroke.

8. The portable tool according to claim 4, wherein said user interface (31) ensures the setting of the value of the determined stroke according to a setting increment smaller than or equal to 3 mm, preferably smaller than or equal to 2 mm, or smaller than or equal to 1 mm.

9. The portable tool according to claim 1, wherein the transmission between the rotor of the electric motor (27) comprises a screw (32)/nut (33) system, configured to transform the rotational movement of the rotor (27) of the motor into a translational movement of the slider (24).

10. The portable tool according to claim 1, wherein the bit (20) comprises a barrel (29) terminating at its distal end in the first bearing surface (21), and connected at its proximal end to a body (34) of the tool embedding the motor, and possibly a reducer (35) as well as the monitoring module (30), the tubular barrel comprising a housing forming a slide (23) for the slider (24), with blockage of the rotation of the slider (24) relative to the barrel about a longitudinal axis of the barrel.

11. The portable tool according to claim 9, wherein the screw (32) of the screw-nut system extends inside the barrel, guided in rotation by a rolling bearing (36) connecting the screw and the inner wall of the barrel, and said nut is mounted movable in translation inside the housing, without any possibility of rotation of the nut relative to the barrel around a longitudinal axis of the barrel.

12. The portable tool according to claim 11, wherein the bit (20) and the body (34) of the tool comprise removable fastening means between the proximal end of the barrel (29) and the body of the tool, comprising for example a retaining ring (340) and wherein the end of the screw (32) at the proximal end of the barrel, on the one hand, and the output of the reducer (35) of the body of the tool, on the other hand, comprise removable complementary portions (37, 38) for coupling by nesting, ensuring a torque transmission.

13. The portable tool according to claim 4, considered in combination with one of claims 10 to 12, wherein the user interface (31) is located on the rear portion of the body of the tool, diametrically opposite with respect to the bit (20) connected to the front portion of the body of the tool.

14. The portable tool according to claim 1, wherein the tool comprises a grip (40), and wherein said control member (28) is a trigger configured to be pressed by a finger such as the forefinger of the hand grasping the grip.

15. The portable tool according to claim 1, wherein the energy source of the motor (M) and of the monitoring module (30) is a battery (39), possibly provided removable with respect to the body (34) of the tool.

16. The portable tool according to claim 1, wherein the monitoring module (30) comprises a selector (41) of the rotation direction of the motor, configured to take on two states, including:
a first state in which a press on the control member (28) causes the rotation of the motor in the direction allowing the advance of the slider (24) from the first position (P1) towards the second position (P2x, P2y),
a second state in which a press on the control member (28) causes the rotation of the motor in the direction allowing the return of the slider from the second position (P2x, P2y) towards the initial first position (P1).
